(19) United States
(12) Patent Application Publication
(10) Pub. No.: US 2025/0378047 A1
(43) Pub. Date: Dec. 11, 2025

(54) SYSTEM AND METHOD FOR OPTIMIZING ANALYTICAL WORKLOADS BASED ON DATA REDUCTION

(71) Applicant: Dell Products L.P., Round Rock, TX (US)

(72) Inventors: BORIS SHPILYUCK, Ashdod (IL); MAXIM BALIN, Gan-Yavne (IL); IGOR DUBROVSKY, Beer Sheva (IL); NISAN HAIMOV, Beer Sheva (IL)

(21) Appl. No.: 18/735,759

(22) Filed: Jun. 6, 2024

(51) Int. Cl. G06F 16/17; G06F 16/182

(52) U.S. Cl. CPC G06F 16/1727; G06F 16/1827

(57) ABSTRACT

Methods and systems for managing distribution of data. Distribution of data in a system may consume limited computing resources. To manage the computing resources used for data distribution, data that may be distributed may be reduced in size. The amount of reduction may be set based on criteria. The resulting distributed reduced size data may be usable for various purposes including, for example, providing computer implemented services. The computer implemented services may be any type and quantity of services.

### FIELD

Embodiments disclosed herein relate generally to user accessibility management. More particularly, embodiments disclosed herein relate to systems and methods to manage user accessibility based on data in a data management system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIG. 3 shows a flow diagram illustrating a method of managing use of data to provide computer implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing use of data to provide computer-implemented services. To manage the use of data may include collection, transmission, and/or storage of data between a data originator and a data user. The data may include copious amount of data for processing which may consume computational resources (e.g., power consumption, resources for transmission of the data, etc.) and may cause time delays for transmission of and/or processing of the data. To reduce delays and resource consumption during transmission and processing of data, the data may be subjected to various reduction processes performed by the data originator. The data originator may collect a portion of data and perform a reduction process using a reduction factor and data reduction algorithm to obtain a reduce size portion of the data.

The data originator may update the reduction factor used in performing the reduction process as new information regarding criteria used in evaluating acceptability of the reduction factor is obtained. By proactively updating the reduction factor used for different types of data in reduction processes, the data originator may be more likely to maximize the reduction amount of the data to be provided while enabling the data user to facilitate performance of computer-implemented services as desired. By managing reduction factors based on evaluation criteria established by a data user, the system may automatically and/or semiautomatically manage how data is being reduced and transmitted from a data originator to a data user.

In an embodiment, a method for managing use of data to provide computer implemented services is disclosed. The method may include obtaining, by a data originator, a first portion of the data; reducing, by the data originator, the first portion of data using a first reduction factor and a data reduction algorithm to obtain a reduced size first portion of data, the first reduction factor being based on: a first inference generated by the data originator using a second portion of the data, a second inference generated by the data originator using a size reduced second portion of the data, and evaluation criteria for the first inference and the second inference, the evaluation criteria being usable to identify whether a second reduction factor used to obtain the size reduced second portion of the data is acceptable; and providing, by the data originator and to a data user that is remote to the data originator and operably connected via a network, the size reduced first portion of the data to facilitate performance of a portion of the computer implemented services by the data user.

The data originator lacks capacity to process the first portion of the data in a manner that is necessary for the computer-implemented services to be provided.

The first portion of data and the second portion of data are generated by the data originator at different points in time, the first portion of data being generated after the second portion of data.

Reducing the first portion of the data may include: identifying a type of data of the first portion of data; selecting the data reduction algorithm from a repository based on the identified type of data; generating a configured data reduction algorithm using: the selected data reduction algorithm, and the first reduction factor; and processing the first portion of the data using the configured data reduction algorithm to obtain the reduced size first portion of data.

The repository may include different data reduction algorithms associated with different types of data, and at least two of the different data reduction algorithms being adapted to selectively add portions of a source data to a reduced size source data based on different schemas, and the different schemas being unable to be used on other types of the different types of data from those of the different types of data associated with each of the at least two of the different data reduction algorithms.

The data reduction algorithms may reduce an amount of the data to be provided using a variety of metrics.

The data reduction algorithm may convert the first portion of the data from color to grey scale to reduce a number of bits used to represent pixels.

The data reduction algorithm may downscale the first portion of the data from a higher resolution to a lower resolution.

The data reduction algorithm may selectively exclude at least a portion of the first portion of the data.

The portion of the first portion of the data may include a continuous portion of a scene depicted in the first portion of the data.

The portion of a scene may be selected using an optimization process.

The evaluation criteria may provide a framework for weighing different factors that contribute to identifying reduction factors usable to reduce the second portion of the data, the different factors may include a factor from a list of factors consisting of: computational resources used for generating the first inference and the second inference; accuracy of the first inference and the second inference; and computational resources used to transmit the second portion of the data and the size reduced section portion of the data.

The evaluation criteria may define a threshold for a difference between the first inference and the second inference, the evaluation criteria indicating that the second reduction factor is unacceptable when the difference between the first inference and the second inference exceeds the threshold.

The data user may use the data obtained from multiple data originators to process the data.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

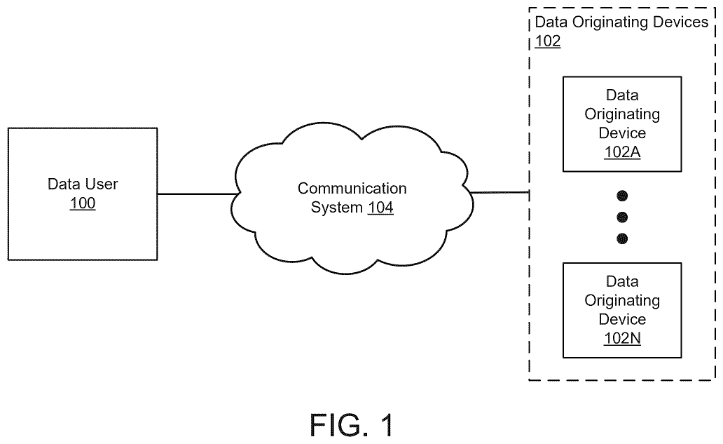

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other type of service that may be implemented with a computing device.

The system may include data user 100. Data user 100 may provide all, or a portion, of the computer-implemented services. To provide the computer-implemented services, data may be managed by data user 100. The data managed by data user 100 may include data usable by an individual or entity for which the data is managed and/or by other individuals to assist the individual or entity. For example, the data may include media data (e.g., video files, audio files, etc.) of a widget production assembly line operated by Company A and the data may be usable by individuals of Company A or other individuals to identify inconsistencies in production of widgets.

The data managed by data user 100 may be collected from data originating devices 102. Data originating devices 102 may include hardware and/or software components configured to obtain data, store data, provide data to other entities, and/or to perform any other task to facilitate performance of the computer-implemented services. The data collected from data originating devices 102 may include any quantity, size, and type of data. For example, a video recording of the widget production assembly line may be obtained from a camera (e.g., data originating device 102A) positioned in the facility of the widget production line in complete view of the production of widgets.

The data collected from data originating devices 102 may be used in data processing methods in order to provide computer-implemented services. However, data originating devices 102 may lack the capacity (e.g., computational resources) necessary to process the data in a desirable manner (e.g., in a practical duration of time) to provide the desired computer-implemented services.

As such, the data collected from data originating devices 102 may be provided to data user 100 to allow analysis of the data by the data user. By providing the data to data user 100, the data may be usable for a variety of purposes. For example, in relation to the widget production example, the data may be usable for performance analytic purposes (e.g., identify potential performance issues), safety purposes, equipment management purposes, etc. While described with respect to widget production context, it will be appreciated that data may be collect, stored, and/or otherwise managed (e.g., by data originating devices 102 and/or data user 100) for other purposes and/or with respect to other contexts. For example, the data may be relevant for other types of services, uses, etc. without departing from embodiments disclosed herein.

However, providing the data from data originating devices 102 to data user 100 may consume a large amount of computational power, high data transmission cost, etc. due to, for example, an increase amount of data to be transmitted and/or may depend on proximity of data originating devices 102 to data user 100. For example, data user 100 may include an analytical system (e.g., analytical component and/or device) located in a geographic location that is remote from data originating device 102A (e.g., device collecting and/or obtain the data) and the computational cost for transmitting the data (e.g., between data originating device 102A and data user 100) may increase as the proximity between data originating device 102 and data user 100 increases.

In general, embodiments disclosed herein may provide methods, systems, and/or devices for managing use of data to provide computer-implemented services. To manage the use of data, data originators may adjust the form in which data is provided to a data user by obtaining a reduced sized portion of the data based on a data reduction factor and data reduction algorithm associated with the type of data. To obtain the data reduction factor that is acceptable to provide the desired computer-implemented services, the reduced size portion of the data and the originated data (e.g., original sized data) may be used in inference generation process to obtain inferences for both portions of the data. Once obtained, the inferences may be compared to evaluation criteria (e.g., established based on a variety of metrics usable by the data user) to determine whether the reduction factor is acceptable in optimizing the amount of data reduced while providing the desired computer-implemented services.

As new information regarding inference accuracy, criteria used to evaluate the inferences, etc. is obtained, the reduction factors associated with different types of data may be updated. For example, utility of the information derived from inferences may increase and as such the value of accurate inferences for a portion of data may increase thereby causing adjustments to the reduction factors considered during evaluation of the inference.

By dynamically updating the reduction factors for different type of data over time, embodiments disclosed herein may provide a system that is more likely to adjust the manner in which an amount of data is reduced to improve the ability of providing accurate inferences usable by data users. The disclosed embodiments may do so in an automated and/or semiautomated fashion thereby to improve the use of data (e.g., by a data user) in an efficient manner that facilitates performance of computer-implemented services by the data user.

To provide the above noted functionality, the system of FIG. 1 may include data user 100, data originating devices 102, and communication system 104. Each of these components is discussed below.

Data originating devices 102 may (i) facilitate collection of data, (ii) identify the type of data collected, (iii) perform reduction processes using reduction factors and data reduction algorithms associated with the type of data to obtain a reduced size portion of the data, (iv) provide the reduce size portion of the data to data user 100, (v) receive information including inference data (and/or data derived from inferences) generated by data user 100 (vi) perform an reduction factor management process to identify whether a reduction factor is acceptable for reducing an amount of data to provide (e.g., to data user 100) and/or (vii) otherwise facilitate collection, reduction, and/or transmission of data for data user 100.

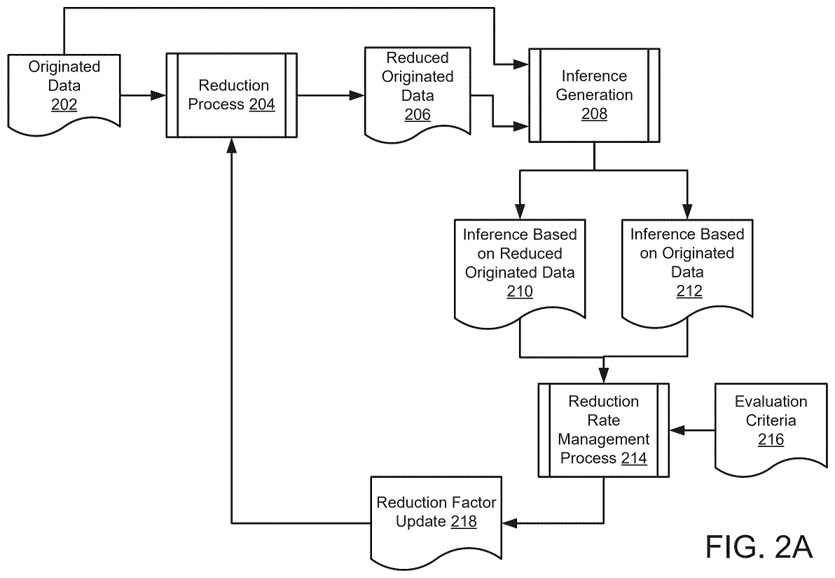

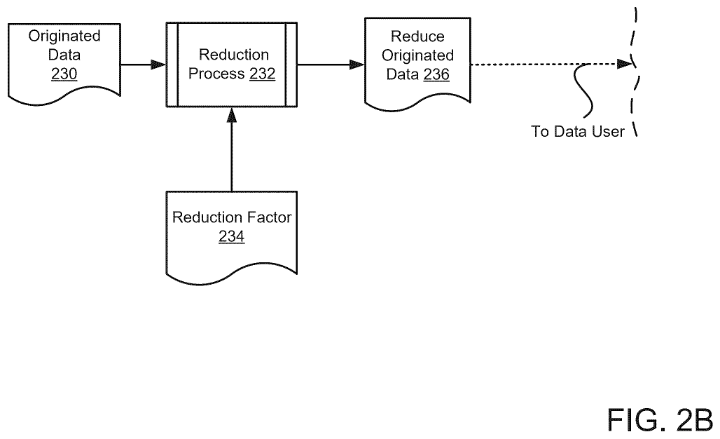

Data originating devices 102 may be include devices which may collect, store, and/or manage data, various types of sensors connected to a computer that collects information (e.g., camera, microphone, etc.), and/or another type of data collection devices. Refer to FIG. 2A for additional details regarding obtaining originated data using data originating devices 102.

To provide computer-implemented services, data user 100 may (i) obtain data from data originating devices 102 (e.g., original sized data and reduced size data), (ii) perform inference generation processes using the original size data and the reduced size data to obtain inferences for both the original size data and the reduced size data, and/or (iii) provide the inferences (and/or data derived from the inferences) to data originating devices 102 to manage reduction factors used for different types of data. Refer to FIG. 2A for additional details regarding managing use of the data.

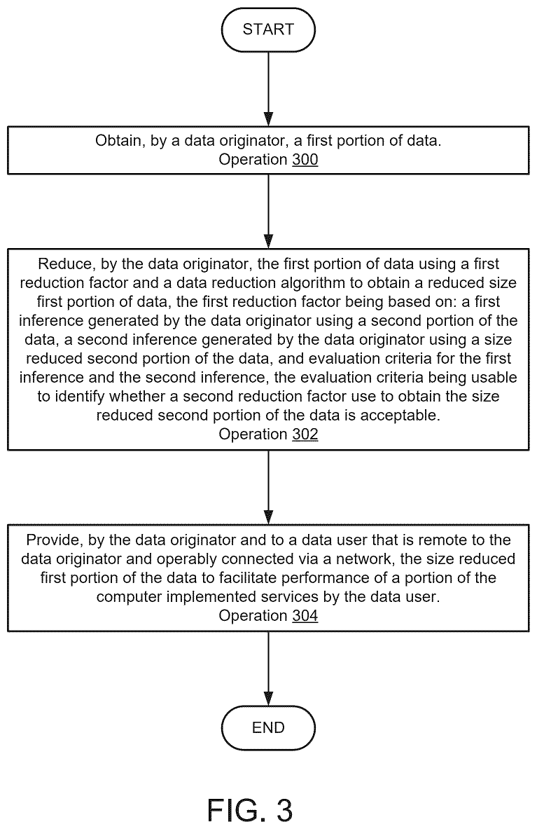

When providing their functionality, any of data user 100, and/or data originating devices 102 may perform all, or a portion, of the methods shown in FIG. 3.

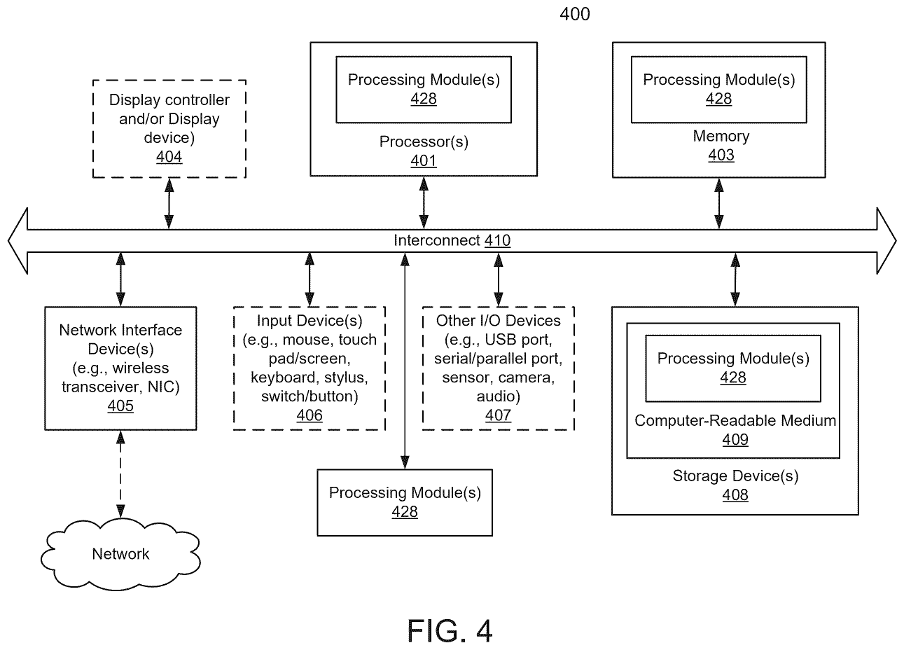

Any of (and/or components thereof) data user 100, and/or data originating devices 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows implemented by a system over time in accordance with an embodiment are shown in FIGS. 2A-2B. In FIGS. 2A-2B, a first set of shapes (e.g., 202, 206) is used to represent data structures, and a second set of shapes (e.g., 204, 208) is used to represent processes performed using data.

Turning to FIG. 2A, a first data flow diagram in accordance with an embodiment is shown. The first data flow diagram may illustrate data used in and data processing performed in reduction of originated data.

To reduce originated data 202, originated data 202 may be obtained by, for example, a data originated device (e.g., 102A shown in FIG. 1). For example, data originated device 102 may include a video camera that captures video recordings of a widget production assembly line that produces widgets for Company A.

Once originated data 202 is obtained, reduction process 204 may be performed to prepare originated data 202 for transmission (e.g., to an external entity) for inference generation. During reduction process 204, originated data 202 may be ingested. After ingestion, originated data 202 may be subject to any number of reduction processes. Some of the reduction processes may be defined by data reduction algorithms associated with different types of data.

For example, reduction process 204 may obtain a reduction factor algorithm corresponding to the type of data from a repository (e.g., not explicitly shown). The repository may store different data reduction algorithms associated with different types of data, and at least two of the different data reduction algorithms being adapted to selectively add portions of a source data to a reduced size source data based on different schemas. The different schemas may be unable to be used on other types of data that differ from the types of data associated with each of the two different data reduction algorithms.

For example, reduction process 204 may use a type of originated data 202 as a key to perform a look up for any number of corresponding data reduction algorithms stored in the repository based on the identified type of originated data 202. The data reduction algorithms may reduce an amount of the data to be provided using a variety of metrics. For example, the data reduction algorithms may convert originated data 202 from color to grey scale to reduce a number of bits used to represent pixels (e.g., reducing an amount of information defining the pixels).

As an additional example, the data reduction algorithms may reduce an amount of data to be provided by reducing fidelity of the data via downscaling the data from a higher resolution to a lower resolution (e.g., averaging a group of pixels and generating an average value to represent the group of pixels thereby reducing the size of the data).

Once selected, the data reduction algorithm and a reduction factor (e.g., associated with the type of data) may be used to generate a configured data reduction algorithm. Once generated, various actions (e.g., data removal actions) specified by the configured data reduction algorithm may be performed on the ingested originated data 202 to complete a first reduction of the data to obtain reduced originated data 206. The resulting reduced originated data 206 may be smaller in size from originated data 202 thereby reducing the computational power to generate an inference for originated data 202.

Once obtained, originated data 202 and reduced originated data 206 may be provided to an analysis system (e.g., data user 100) to generate inferences for both portions of the data (e.g., originated data 202 and reduced originated data 206). For example, originated data 202 may be used to generate a first inference based on original sized data and reduced originated data 206 may be used to generate a second inference while using less computational power due to the reduction in the size of the data.

Inference generation process 208 may be performed to generate inferences for both the original sized data and the reduced sized data (e.g., originated data 202 and reduced originated data 206, respectively). During inference generation process 208, originated data 202 and reduced originated data 206 may be used to generate a first inference and a second inference, respectively. For example, originated data 202 and reduced originated data 206 may be ingested into an inference model trained to generate inferences based on the data. The result of performing inference generation process 208 may be inference based on reduced originated data 210 and inference based on originated data 212.

The inferences (e.g., inference based on reduced originated data 210 and inference based on originated data 212) may include sensitive information that may be consequential if distributed to an external entity (e.g., another entity not generating the inferences). Various data masking techniques may be used to limit the use of the inferences except for comparisons to see if similar inferences have been generated. Thus, some data derived based on the inferences may be provided in order to perform reduction rate management process 214. For example, the derived data may include a first dimensional-less magnitude based on the first inference and a second dimensional-less magnitude based on the second inference.

Inference based on reduced originated data 210 and inference based on originated data 212 may be provided to the data originator (e.g., 102A) to perform an analysis of the inferences to determine whether a reduction factor is acceptable based on evaluation criteria (e.g., established by data user 100).

Examples of evaluation criteria 216 may be cost benefit factors that may be taken into account in performing the reduction rate management process 214, however the evaluation criteria may also include other factors which may be evaluated during the reduction rate management process. For example, evaluation criteria 216 may include benefits of reducing the size of the data (e.g., originated data 202) such as computational power reduction, computation power savings, data transmission cost reduction, etc. Evaluation criteria 216 may also include costs of reducing the size of the data such as computational cost for performing reduction processes, loss of inference capabilities based on the reduction factor, etc.

Reduction rate management process 214 may be performed to identify whether the reduction factor used in reduction process 204 to obtain reduced originated data 206 is acceptable. During reduction rate management process 214, inference based on reduced originated data 210 and inference based on originated data 212 may be analyzed using evaluation criteria 216 to identify whether the reduction factor is acceptable. The accuracy of inferencing may decrease (e.g., proportionally) as the fidelity of the data of which the inferences are based on decreases, however, the value of accurate inferences may depend on various factors (e.g., evaluation criteria 216) established by the data user (e.g., 100). For example, the value of accurate inferences of video recordings for counting widgets produced on an assembly line may have minimal impact to Company A if the count of total widgets is off by a small percentage (e.g., 10 widgets out of 100,000 widgets). Conversely, the value of accurate inferencing of video recordings for identifying whether widgets are properly deburred (e.g., process to remove sharp edges or inconsistencies from the material of the widget) may have significant consequences to Company A if a small percentage (or even one) widget is not deburred prior to distribution to an end user of the widget to potentially cause harm to the end user.

Through reduction rate management process 214, reduction factor update 218 may be obtained. Reduction factor update 218 may include information regarding the reduction factor associated with the type of data for which the reduction process is being performed. Depending on the outcome of reduction rate management process 214, the reduction factor update 218 may identify whether the reduction factor is to be maintained (e.g., kept the same) or a change to the reduction factor is needed. For example, evaluation criteria 216 may define a threshold for a difference between the first inference (e.g., inference based on reduced originated data 210) and the second inference (e.g., inference based on originated data 212). If the difference between the first inference and the second inference is within the threshold, reduction factor update 218 may identify that no change to the reduction factor is needed (e.g., confirmation to keep using the same reduction factor for the associated type of data). Conversely, if the difference between the first inference and the second inference exceeds the threshold, reduction factor update 218 may include a new reduction factor to be used in performing reduction process 204.

Reduction factor update 218 may be used, in conjunction with data reduction algorithms associated with the respective type of data, to reduce the size of originated data (e.g., data obtained by data originated devices 102) during performance of reduction process 204.

While described with respect to one portion of originated data (e.g., 202), the data flow shown in FIG. 2A may be performed multiple times for multiple different types of originated data to obtain any number of corresponding reduction factor updates. Thereby establishing different media reduction processes for different types of originated data.

Turning to FIG. 2B, a second data flow diagram illustrating data flows, data processing, and/or other operations that may be performed by the system of FIG. 1 in accordance with an embodiment is shown. The second data flow diagram may illustrate data used in and data processing performed in reducing data in preparation of providing to data users.

To reduce data in preparation of providing to data users, originated data 230 may be obtained and used in performance of various reduction processes. Originated data 230 may include different types of data obtained at different points in time by a data originated device (e.g., 102A shown in FIG. 1). Continuing the above-described example, video recordings (e.g., originated data 230) of a widget production assembly line including different dates and times of widget production may be obtained by a camera positioned in view of the widget production assembly line. The video recordings may include content that is not relevant for providing the desired computer-implemented services (e.g., counting widgets produced).

Originated data 230 may be used during reduction process 232. Reduction process 232 may be performed to reduce the size of the data based on a selected reduction factor (e.g., reduction 234). During reduction process 232, originated data 230 may be ingested into a data reduction algorithm (e.g., obtained from a repository which stores different data reduction algorithms corresponding to different types of data) and using reduction factor 234 to obtain a reduced size data. Reduced originated data 236 may be provided to a data user from the data originator (e.g., data originated device 102A) to facilitate performance of a portion of the computer-implemented services by the data user.

Once obtained, reduced originated data 236 may be used to facilitate performance of more efficient computer-implemented services provided by a data user by obtaining reduced size data based on a reduction factor and reduction data algorithm customized to accommodate the respective type of data in an automated manner.

Turning to FIG. 3, a flow diagram illustrating a method for managing use of data to provide computer implemented services in accordance with an embodiment is shown. The method may be performed, for example, by any of data user 100, data originated devices 102, and/or other components of the system shown in FIGS. 1-2B.

Prior to operation 300, data reduction algorithms may be obtained (e.g., by a data originated device) and stored in a repository within the data originated device. The data reduction algorithms may be obtained through various processes such as generation, acquisition from external entity, and/or by any other method. The repository may include different data reduction algorithms associated with different types of data. At least two of the different data reduction algorithms may be adapted to selectively add portions of a source data to a reduced size source data based on different schemas, and the different schemas being unable to be used on other types of data (e.g., different from the types of data associated with the two different data reduction algorithms). The data reduction algorithms may be used to reduce an amount of data to be provided using a variety of metrics (e.g., reducing fidelity of the data, excluding portion(s) of the data, etc.).

At operation 300, a first portion of data may be obtained. The first portion of the data may be obtained by (i) generating the first portion of the data, (ii) receiving the first portion of the data from an external device, and/or (iii) via any other methods to obtain the first portion of the data.

At operation 302, the first portion of the data may be reduced using a first reduction factor and a data reduction algorithm to obtain a reduced size first portion of data. The first reduction factor may be based on: a first inference generated by the data originator using a second portion of the data, a second inference generated by the data originator using a size reduced second portion of the data, and evaluation criteria for the first inference and the second inference, the evaluation criteria being usable to identify whether a second reduction factor used to obtain the size reduced second portion of the data is acceptable.

Reducing the first portion of the data may be facilitated by: (i) identifying a type of data of the first portion of the data, (ii) selecting the data reduction algorithm from a repository based on the identified type of data, (iii) generating a configured data reduction algorithm using: the selected data reduction algorithm, and the first reduction factor, and/or (iv) processing the first portion of the data using the configured data reduction algorithm to obtain the reduced size first portion of data.

At operation 304, the size reduced first portion of the data may be provided. The size reduced first portion of the data may be provided by the data originator and to a data user that is remote to the data originator and operably connected via network to facilitate performance of a portion of the computer implemented services by the data user. The size reduced first portion of the data may be provided by (i) electronic transmission of the size reduced first portion of the data via a network connecting the data originator and the data user, (ii) storing the size reduced first portion of the data in a storage device accessible by the data user, and/or (iii) by any other methods.

Using the methods illustrated in FIG. 3, embodiments disclosed herein may facilitate management of data usage to provide computer implemented services. Managing use of data may include obtaining size reduced data by performing various reduction processes based on the type of data and a selected reduction factor. The size reduced data may be provided to a data user to facilitate performance of a portion of computer implemented services by the data user.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing use of video data at a production assembly line to provide computer implemented services, the method comprising:
obtaining, by a video camera of a data originator at the production assembly line, a first portion of the video data;
reducing, by the data originator, the first portion of the video data using a first reduction factor and a data reduction algorithm to obtain a reduced size first portion of data, the reduced size first portion having at least one of a different color scale or a different resolution than the first portion of the video data, the first reduction factor being based on:
a first inference on production performance generated by the data originator using a second portion of the video data,
a second inference on the production performance generated by the data originator using a size reduced second portion of the video data, and
evaluation criteria for the first inference and the second inference, the evaluation criteria being usable to identify whether a second reduction factor used to obtain the size reduced second portion of the video data is acceptable; and
providing, by the data originator and to a data user that is remote to the data originator and operably connected via a network, the size reduced first portion of the video data to facilitate performance of a portion of the computer implemented services by the data user.

2. The method of claim 1, wherein the data originator lacks capacity to process the first portion of the video data in a manner that is necessary for the computer-implemented services to be provided.

3. The method of claim 1, wherein the first portion of the video data and the second portion of the video data are generated by the data originator at different points in time, the first portion of the data being generated after the second portion of the video data.

4. The method of claim 1, wherein reducing the first portion of the video data comprises:
identifying a type of video data of the first portion of the video data;
selecting the data reduction algorithm from a repository based on the identified type of data;
generating a configured data reduction algorithm using:
the selected data reduction algorithm, and
the first reduction factor; and
processing the first portion of the video data using the configured data reduction algorithm to obtain the reduced size first portion of data.

5. The method of claim 4, wherein the repository comprises different data reduction algorithms associated with different types of data, and at least two of the different data reduction algorithms being adapted to selectively add portions of a source data to a reduced size source data based on different schemas, and the different schemas being unable to be used on other types of the different types of data from those of the different types of data associated with each of the at least two of the different data reduction algorithms.

6. The method of claim 1, wherein the data reduction algorithm reduces an amount of the video data to be provided using a variety of metrics.

7. (canceled)

8. (canceled)

9. The method of claim 6, wherein the data reduction algorithm selectively excludes at least a portion of the first portion of the video data.

10. The method of claim 9, wherein the portion of the first portion of the video data comprises a continuous portion of a scene depicted in the first portion of the video data.

11. The method of claim 10, wherein the portion of a scene is selected using an optimization process.

12. The method of claim 1, wherein the evaluation criteria provides a framework for weighing different factors that contribute to identifying reduction factors usable to reduce the second portion of the video data, the different factors comprising a factor from a list of factors consisting of:
computational resources used for generating the first inference and the second inference;
accuracy of the first inference and the second inference; and
computational resources used to transmit the second portion of the video data and the size reduced section portion of the video data.

13. The method of claim 1, wherein the evaluation criteria defines a threshold for a difference between the first inference and the second inference, the evaluation criteria indicating that the second reduction factor is unacceptable when the difference between the first inference and the second inference exceeds the threshold.

14. The method of claim 1, wherein the data user uses the video data obtained from multiple data originators to process the video data.

15. A non-transitory machine-readable medium having instructions stored therein, which when executed by a processor, cause the processor to perform operations for managing use of video data at a production assembly line to provide computer implemented services, the operations comprising:
obtaining, by a video camera of a data originator at the production assembly line, a first portion of the video data;
reducing, by the data originator, the first portion of the video data using a first reduction factor and a data reduction algorithm to obtain a reduced size first portion of data, the reduced size first portion having at least one of a different color scale or a different resolution than the first portion of the video data, the first reduction factor being based on:
a first inference generated by the data originator using a second portion of the video data,
a second inference generated by the data originator using a size reduced second portion of the video data, and
evaluation criteria for the first inference and the second inference, the evaluation criteria being usable to identify whether a second reduction factor used to obtain the size reduced second portion of the video data is acceptable; and
providing, by the data originator and to a data user that is remote to the data originator and operably connected via a network, the size reduced first portion of the video data to facilitate performance of a portion of the computer implemented services by the data user.

16. The non-transitory machine-readable medium of claim 15, wherein the data originator lacks capacity to process the first portion of the video data in a manner that is necessary for the computer-implemented services to be provided.

17. The non-transitory machine-readable medium of claim 15, wherein the first portion of the video data and the second portion of the video data are generated by the data originator at different points in time, the first portion of the video data being generated after the second portion of the video data.

18. A data processing system, comprising:
a processor; and
a memory coupled to the processor to store instructions, which when executed by the processor, cause the processor to perform operations for managing user interactions between a user and at least one user device, the operations comprising:
obtaining, by a video camera of a data originator, a first portion of video data at a production assembly line;
reducing, by the data originator, the first portion of the video data using a first reduction factor and a data reduction algorithm to obtain a reduced size first portion of data, the reduced size first portion having at least one of a different color scale or a different resolution than the first portion of the video data, the first reduction factor being based on:
a first inference generated by the data originator using a second portion of the video data,
a second inference generated by the data originator using a size reduced second portion of the video data, and
evaluation criteria for the first inference and the second inference, the evaluation criteria being usable to identify whether a second reduction factor used to obtain the size reduced second portion of the video data is acceptable; and
providing, by the data originator and to a data user that is remote to the data originator and operably connected via a network, the size reduced first portion of the video data to facilitate performance of a portion of the computer implemented services by the data user.

19. The data processing system of claim 18, wherein the data originator lacks capacity to process the first portion of the video data in a manner that is necessary for the computer-implemented services to be provided.

20. The data processing system of claim 18, wherein the first portion of the video data and the second portion of the video data are generated by the data originator at different points in time, the first portion of the video data being generated after the second portion of the video data.

21. The data processing system of claim 18, wherein reducing the first portion of the video data comprises:
identifying a type of video data of the first portion of the video data;
selecting the data reduction algorithm from a repository based on the identified type of data;
generating a configured data reduction algorithm using:
the selected data reduction algorithm, and
the first reduction factor; and
processing the first portion of the video data using the configured data reduction algorithm to obtain the reduced size first portion of data.

22. The data processing system of claim 21, wherein the repository comprises different data reduction algorithms associated with different types of data, and at least two of the different data reduction algorithms being adapted to selectively add portions of a source data to a reduced size source data based on different schemas, and the different schemas being unable to be used on other types of the different types of data from those of the different types of data associated with each of the at least two of the different data reduction algorithms.
